(19) United States
(12) Patent Application Publication
(10) Pub. No.: US 2026/0100924 A1
(43) Pub. Date: Apr. 9, 2026

(54) METHODS AND SYSTEMS FOR GENERATING QUESTIONS FOR GUIDED REFLECTION

(71) Applicant: Sequelae, Inc., Minneapolis, MN (US)

(72) Inventors: Scott Archibald, Wayzata, MN (US); Ryan Michael Rodeback, Edina, MN (US); Sara Taylor, Edina, MN (US); Natalie Sheils, St. Paul, MN (US); Danielle Marria Martin, Minneapolis, MN (US); John Michael Gray, San Diego, CA (US)

(73) Assignee: Sequelae, Inc., Minneapolis, MN (US)

(21) Appl. No.: 19/351,745

(22) Filed: Oct. 7, 2025

Related U.S. Application Data
(60) Provisional application No. 63/704,196, filed on Oct. 7, 2024.

(51) Int. Cl. H04L 51/02; G06Q 50/00

(52) U.S. Cl. CPC H04L 51/02; G06Q 10/40

(57) ABSTRACT

Methods and systems for generating questions for guided reflection are provided. A digital communication network (DCN) is provided for a plurality of members of a population to communicate with each other and/or the DCN. An individual member is identified from the plurality of members and one or more communications of the individual member are analyzed. A topic of reflection from a plurality of topics of reflection is determined based on the analysis and a question is automatically generated based on the topic of reflection. The question is transmitted to the individual member via the DCN.

### CROSS REFERENCE TO RELATED APPLICATIONS

This application claims the benefit of U.S. Provisional Application No. 63/704,196, filed on Oct. 7, 2024, which application is incorporated herein by reference in its entirety.

### BACKGROUND

Various embodiments relate generally to methods and systems for generating questions for an individual member in a digital communication network (DCN) and in particular, to generating questions based on a determined topic of reflection.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

People often take actions—whether simple, hard, good, or bad, etc.—that impact their health. Regardless, such actions have consequences that can accumulate over time. However, rarely do people associate such actions with consequences. This may be due to, for example, the lack of data to see the consequence (or the data is available in a way that does not connect to the action). Other times, they may not think about the connection between the action and the consequence. Reflecting on their conditions can help people associate actions with their consequences; thus, it is desirable for people to reflect on their actions and potential consequences.

Mindfulness, as gained through reflection, is an essential part of self-improvement. Unless someone is aware of their behaviors and how those behaviors impact the things that are important to them, it is very hard to sustain change in their behaviors.

Reflection is the process by which people gain that understanding. Reflecting takes conscience effort and is often emotionally draining and cognitively draining. Thus, a person may find it easier to not reflect on such actions.

Computers have changed the way people interact. Digital networks, which may include the use of social media, allow individuals to interact with others online and connect many people with a community. The online community can be utilized to help build positive behaviors and encourage people to make improvements in their lives. Computers can also provide a way for people to record their actions and review them later as well as to enable a person to reflect on their activities.

What is needed is a way to guide reflection using questions generated based on determined topics of interest to assist in treating a lifestyle condition using a digital communication network.

### SUMMARY

Example aspects of the present disclosure include:

A method according to at least one embodiment of the present disclosure comprises providing a digital communication network (DCN) for a plurality of members of a population to communicate; identifying an individual member of the plurality of members; analyzing one or more communications of the individual member; determining a topic of reflection from a plurality of topics of reflections based on the analysis of the one or more communications; generating automatically a question based on the topic of reflection, the question designed to cause the individual member to connect an outcome experienced by the individual member with a decision the individual member has made; and transmitting the question to the individual member via the DCN.

Any of the aspects herein, further comprising: determining a phenotype of the individual member based on the analysis of the one or more communications, wherein the plurality of topics of reflections is based, at least in part, on the phenotype of the individual member.

Any of the aspects herein, further comprising: receiving an answer to the question from the individual member; and transmitting at least one follow-up question based at least in part on the answer.

Any of the aspects herein, further comprising: receiving an answer to the question from the individual member; and posting the answer to the DCN.

Any of the aspects herein, wherein the method is used to at least one of to manage a disease risk in the population, lower a risk of health care expenditures, or to slow or reverse progression of an adverse health condition in the individual member.

Any of the aspects herein, further comprising: generating an ontology of health conditions for the individual member, wherein the ontology of health conditions comprises the adverse health condition.

Any of the aspects herein, wherein the topic of reflection is at least one of an inspirational quote the individual member has identified as useful; a piece of music, a movie, a piece of art, a selection of prose, or a piece of poetry the individual member has identified as appreciating; a daily routine a life event; a time of year; a season; a time of day; a diagnosis; an injury; an elective medical procedure; a current challenge which the individual member has given themselves or is experiencing; a relationship; or a planned or unplanned trip.

Any of the aspects herein, wherein the topic of reflection is determined by the individual member selecting the topic of reflection from the plurality of topics of reflections.

Any of the aspects herein, wherein transmitting the question to the individual member includes transmitting an incentive to answer the question with the question.

Any of the aspects herein, wherein the one or more communications include one or more observations by the individual member regarding to a life, lifestyle, or health of the individual member.

A system according to at least one embodiment of the present disclosure comprises a computer processor; a data repository in communication with the computer processor and storing: one or more communications having one or more observations by the individual member regarding to a life, lifestyle, or health of the individual member; a plurality of topics of reflections; and a question; a digital communications network which, when executed by the computer processor, provides a network for a plurality of members of a population to interact with each other; and a server controller which, when executed by the computer processor: identifies an individual member of the plurality of members; analyzes the one or more communications; determines a topic of reflection of the plurality of topics of reflections based on the analysis of the one or more communications; generates the question based on the topic of reflection, the question designed to cause the individual member to connect an outcome experienced by the individual member with an action the individual member has taken; and transmits the question to the individual member.

Any of the aspects herein, wherein the server controller which, when executed by the computer processor, further: determines a phenotype of the individual member based on the analysis of the one or more communications, wherein the plurality of topics of reflections is based, at least in part, on the phenotype of the individual member.

Any of the aspects herein, wherein the server controller which, when executed by the computer processor, further: receives an answer to the question from the individual member; and transmits at least one follow-up question based at least in part on the answer.

Any of the aspects herein, wherein the server controller which, when executed by the computer processor, further: receives an answer to the question from the individual member; and posts the answer to the DCN.

Any of the aspects herein, wherein the system is used to at least one of to manage a disease risk in the population, lower a risk of health care expenditures, or to slow or reverse progression of an adverse health condition in the individual member.

Any of the aspects herein, wherein the server controller which, when executed by the computer processor, further: generates an ontology of health conditions for the individual member, wherein the ontology of health conditions comprises the adverse health condition.

Any of the aspects herein, wherein the topic of reflection is at least one of an inspirational quote the individual member has identified as useful; a piece of music, a movie, a piece of art, a selection of prose, or a piece of poetry the individual member has identified as appreciating; a daily routine a life event; a time of year; a season; a time of day; a diagnosis; an injury; an elective medical procedure; a current challenge which the individual member has given themselves or is experiencing; a relationship; or a planned or unplanned trip.

Any of the aspects herein, wherein the topic of reflection is determined by the individual member selecting the topic of reflection from the plurality of topics of reflections.

Any of the aspects herein, wherein transmitting the question to the individual member includes transmitting an incentive to answer the question with the question.

A method according to at least one embodiment of the present disclosure comprises providing a digital communication network (DCN) for a plurality of members of a population to communicate; identifying an individual member of the plurality of members; analyzing one or more communications including at least one of an ongoing conversation between the DCN and the individual member or a previous conversation between the DCN and the individual member; and determining a subsequent communication for at least one of the ongoing conversation or the previous conversation based at least in part on the analysis of the one or more communications.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present disclosure will become apparent to those skilled in the art upon consideration of the embodiment descriptions provided hereinbelow.

### BRIEF DESCRIPTION OF THE DRAWINGS

Aspects of the described embodiments are more evident in the following description, when read in conjunction with the attached Figures.

FIG. 1 shows a simplified block diagram of devices, in accordance with one or more embodiments.

FIG. 2 is a logic flow diagram that illustrates the operation of a method, in accordance with one or more embodiments.

FIG. 3 is a logic flow diagram that illustrates the operation of a method, in accordance with one or more embodiments.

FIG. 4A shows an example of a computing system, in accordance with one or more embodiments.

FIG. 4B shows an example of a network, in accordance with one or more embodiments.

### DETAILED DESCRIPTION

Reflection is normally considered after an event. A person can observe a change and reflect on the cause of that change. This reflection helps understand why a change, good or bad, had occurred and can teach the person how to achieve better results.

Often these changes are observed through objective data, such as, a biometric sample, results tracked through a smartwatch, or some other means that bring the change to life. When observations are made, reflection before the result is known can provide a way to make a post-observation reflection more powerful. Various embodiments use a digital communication network (DCN) to encourage an individual to also reflect before a biometric test result is known in order to improve the effectiveness of reflection to assist in treating a medical condition.

Reflections are an important part of a person's experience. They allow the person to turn observations about the connection between their actions and the consequences of those actions into useable insight. Digital health applications typically provide people access to data about their health or health-related actions and often allow them to record observations about how they feel. This can cause reflection but in a minimal way.

Reflection may be considered as part of the change process—a person does or observes something, and then reflects on the action or observation and the consequences. This process implies some degree of planning, either in adding reflection to a planned action, or scheduling periods to reflect (these can be formal as in professional counseling). Unfortunately, much of life is unplanned and unobserved.

A person can reflect on many aspects of their experience. The topic of their reflection can help the person focus on specific elements. These elements can improve the reflection process, for example, by enabling the person to make a personal connection with the reflections, such as, associating the process with an inspirational quote, music, movie, etc.

The topic may also highlight parts of the person's life that may be impacted by the lifestyle condition. The topic may help the person identify changes in their daily routines, the time of day, the time of year and/or upcoming life events due to their lifestyle condition. Conversely, the person may reflect upon how the lifestyle condition may be influenced by their daily routines, the time of day, the time of year and/or upcoming life events.

Various embodiments overcome those problems, for example, by guiding a reflection based on an identified topic of reflection to assist in treating a lifestyle condition. By guiding the reflection, the person reflecting on their lifestyle condition can better understand their situation and can be better positioned to handle their lifestyle condition.

In some embodiments, the DCN presents an individual member with opportunities to reflect on a topic. The DCN may send a message to the individual member requesting a response regarding the topic. The message may be part of a conversion the individual member is having with a bot in the DCN. Additionally, the DCN may incentivize the reflection, for example, offering rewards for responding. The rewards may be an offer to participate in events, discounts, messaging icons, etc.

The DCN can analyze the individual member's communications in the DCN in order to select a topic for reflection. This can help identify aspects that the individual member is passionate about and/or shows specific interest in. The DCN may also base the topic on various other factors, for example the individual member's phenotype, the lifestyle condition, biological test results, family history, etc.

The DCN may also time the reflection requests so as to improve the reflection. As one non-limiting example, the DCN may analyze posts about what the individual member is eating to determine their eating cycle. The DCN can then time sending a request for the member to reflect on their lifestyle condition at a point shortly after the individual member is expected to have completed a meal.

The DCN may also follow-up on the communications by requesting additional reflection from the individual member. For example, the DCN may ask the individual member to reflect on the factors that caused their response to the automated message. The individual member may respond to the follow-up request which may lead to further communications. These communications may occur over a single session or multiple sessions. Multiple sessions may take place over a single day or several days (or weeks).

The individual member's responses may be provided in various ways, for example, textual, verbal, visual, or some combination thereof. The DCN may provide a tool for the member to provide the responses, such as a voice capture program to translate speech into text. The individual member may provide detailed impressions, indicate their expected results and/or indicate a level of comfort (or expected level of comfort) with the results.

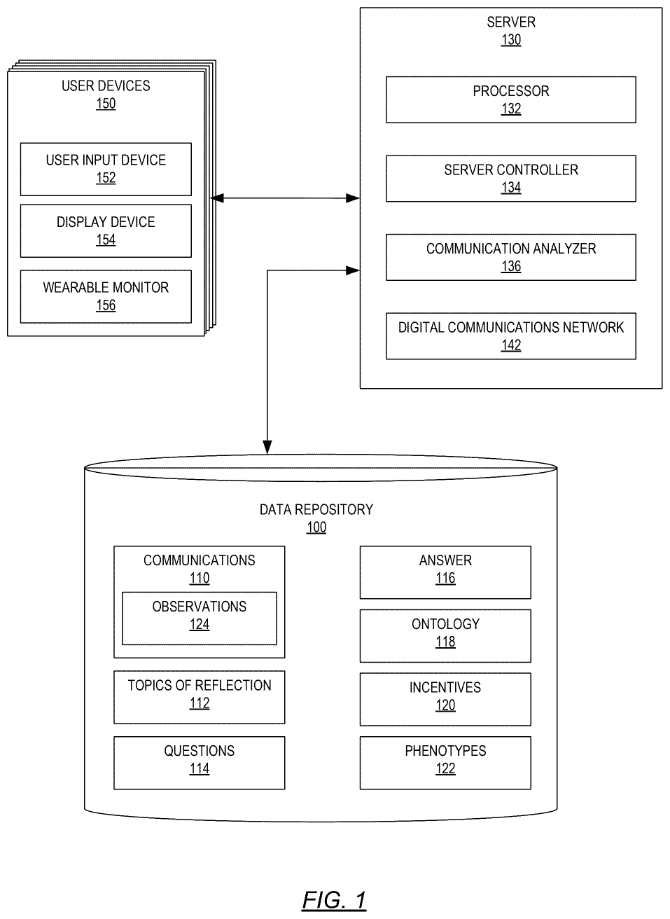

Turning to the Figures, the system shown in FIG. 1 includes a data repository (100). The data repository (100) is a type of storage unit or device (e.g., a file system, database, data structure, or any other storage mechanism) for storing data (described below). The data repository (100) may include multiple different, potentially heterogeneous, storage units and/or devices.

The data repository (100) stores communications (110). The communications (110) are communications from members in a digital communication network (DCN) (142) (described in more detail below). The communications (110) may be, for example, text-based, image-based, multimedia communications, audio communications, or any combinations thereof. The communications may be between members, communications in a forum, communications with the DCN (142), or communications generated by the DCN (142) (e.g., communications from a conversation bot, also referred to as a chat bot).

The communications (110) in the DCN (142) by an individual member may include one or more observations (124). The one or more observations (124) may relate to at least one of the individual member's life, lifestyle or health. The observations (124) may be based in part on biometric data and/or psychometric data, which will be discussed in more detail below. The communications (110) may include, for example, a post and/or a post title that the individual member created in the DCN (142).

The communications (110) may also be referred to as bot communications when the communications are generated and received from one or more conversation bots.

The data repository (100) also stores topics of reflections (112). The topics of reflections (112) can include, for example, an inspirational quote the individual member has identified as useful; a piece of music, a movie, a piece of art, a selection of prose, or a piece of poetry the individual member has identified as appreciating; a daily routine a life event; a time of year; a season; a time of day; a diagnosis; an injury; an elective medical procedure; a current challenge which the individual member has given themselves or is experiencing; a relationship; or a planned or unplanned trip. A particular topic of reflection (112) can be selected by the individual member. In other embodiments, the topic of reflection (112) can be determined by the DCN (142) analyzing communications (110) from the individual member. In such embodiments, the DCN (142) may use, for example, a communication analyzer (136) (described in more detail below) to analyze the communications (110). The communications (110) can be analyzed by, for example, identifying key words or concepts in the communications (110).

The data repository (100) also stores questions (114). The questions (114) are questions directed to the individual member and may include yes/no questions or open-ended questions. The questions (114) may be designed to induce a reflection in the individual member, understand a motivation of the individual member, collect information about the life and lifestyle of the individual member, and/or cause the individual member to connect an outcome experienced by the individual member with a decision made by the individual member or an action the individual member has taken. The questions (114) can include one question, two questions, or more than two questions. The questions (114) may also include a request for the individual member to answer the question (114). The request may include buttons (e.g., yes/no buttons), a text and/or media box for the individual member to type in or attach media.

The data repository (100) also stores answer (116). The answers (116) are answers (116) to the questions (104) received from the individual member. The answers (116) may include, for example, a yes/no answer, text, and/or media (e.g., audio, visual, images, videos, etc.). The answers (116) can be used to generate additional or follow up questions (114). The additional or follow up questions can be used to, for example, solicit additional observations (124).

The data repository (100) also stores an ontology (118). The ontology (118) is a defined set of relationships between the adverse condition, ideas, motivations, and/or reflections and how the adverse condition, ideas, motivations, and/or reflections relate to each other. The ontology (118) is used to, for example, define and show the interdependency of the individual member's adverse condition and reflection.

The data repository (100) also stores incentives (120). The incentives (120) are discounts, coupons, money, or other rewards to incentivize the individual member to answer the questions (114). The incentives (120) may be, for example, a discount or may cover the cost for an activity or an item. The incentive (120) may include one or more incentives (120).

The data repository (100) also stores phenotypes (122). The phenotypes (122) are a collections of aspects that define the individual member's health and wellbeing such as, for example, the diseases and prodromal diseases they manifest, their vital signs, their body measurements and biomarker levels, there emotional state, their age, their fitness state, activity level, diet, allergies, etc.

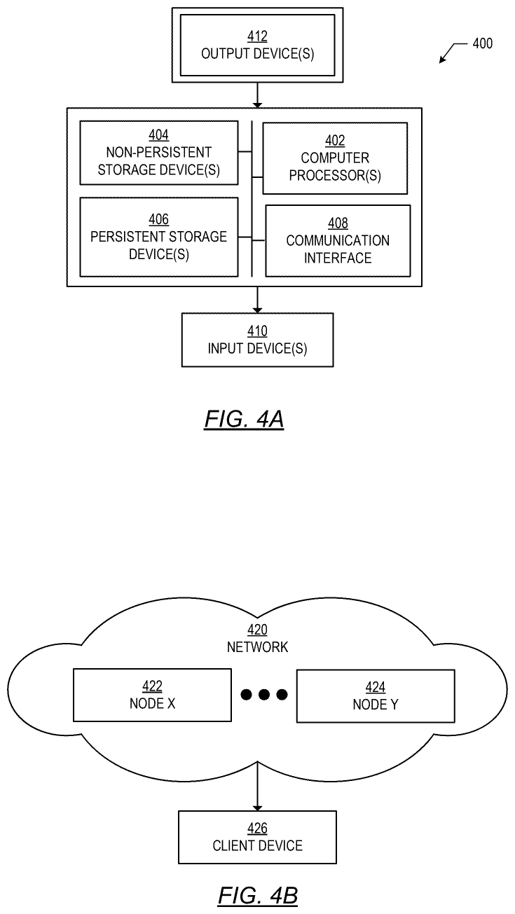

The system shown in FIG. 1 may include other components. For example, the system shown in FIG. 1 also may include a server (130). The server (130) is one or more computer processors, data repositories, communication devices, and supporting hardware and software. The server (130) may be in a distributed computing environment. The server (130) is configured to execute one or more applications, such as a communication analyzer (136). An example of a computer system and network that may form the server (130) is described with respect to FIG. 4A and FIG. 4B.

The server (130) also includes a computer processor (132). The computer processor (132) is one or more hardware or virtual processors which may execute computer readable program code that defines one or more applications, such as the communication analyzer (136). An example of the computer processor (132) is described with respect to the computer processor(s) (402) of FIG. 4A.

The server (130) also may include a server controller (134). The server controller (134) is software or application specific hardware which, when executed by the computer processor (132), controls and coordinates operation of the software or application specific hardware described herein. Thus, the sever controller (134) may control and coordinate execution of the communication analyzer (136).

The server (130) also includes the communication analyzer (136). The communication analyzer (136) is software or application specific hardware which, when executed by the computer processor (132), analyzes communication (110) in the DCN (142), determines the topic of reflection (112) based on the analysis, and generates the questions (114) based on the determined topic of reflection (112). For example, the communication analyzer (136) may receive communications (110) from the individual member and may output the questions (114).

The server (130) also includes the DCN (142). The DCN (142) is a network through which members of a population can interact with each other, or with a system supported by the DCN (142). The DCN (142) can also interact with the members of the population and, for example, transmit communications (110) and the questions (114) to the individual member to induce reflection in the individual member.

In some embodiments, the DCN (142) may be, for example, an artificial intelligence bot configured to derive generated communications from analysis of existing communications (110) in the DCN (142) or biometrics provided to the DCN (142). Biometric data can be used in many instances such as the provisioning and commissioning of healthcare. For example, biometric data can be used to diagnose diabetes, prescribe hypertension medication with a patient's blood pressure exceeds a certain value, prescribe cancer drugs, etc. In another example, cancer drug can be available for reimbursement if a certain genetic signature is present in the tumor. The decision tree and other logic behind these relationships considers many things including what is known about the variance in the intervention's efficacy, therapeutic index, the accuracy and precision in the biometric data's measurement, as well as the cost-benefit ratio of the intervention compared with other interventional options.

The biometric data, as well as reflections from the individual member, can be used in a “feedback” decision tree where, for example, an intervention can be prescribed or recommended to an individual member based on the biometric data and/or the reflections. Then the biometric data or additional reflections can be obtained to study the effects or results of the intervention.

In some embodiments, the conversation bot may use a visual or graphical interface, for example, a rendered avatar, or a plot or image from the bot or sharing one with the bot. The DCN (142) can send a visual representation showing that person's data from a wearable, their interaction with the community, their consistency in talking with the bot, etc. The conversation bot may then ask questions like “What do you notice” or “Is anything here surprising” in order to induce a reflection from the individual member.

The conversation bot can analyze data from various sources, in part, to formulate its communications with the individual member. These sources include data from i) the DCN (142), ii) the ongoing conversation with the individual member, and iii) previous conversations with the individual member. The conversation bot can also use temporal and situational cues to formulate its communication next with the member. When analyzing the data, the conversation bot may quote sections of the conversations for use with communications between the individual member and/or the conversation bot may identify patterns in the discussions. When formulating the communications, the conversation bot can analyze exchanges in the DCN (142) from other members. These communications can be limited to specifically target individuals, such as those deemed to be close contacts to the individual member or members that are considered influencers.

One-to-one communications with the conversation bot can be triggered and informed by one-to-many communications in the DCN (142), and conversations with the conversation bot can (a) refer individuals to the relevant communications in the DCN (142), (b) suggest posts to the DCN (142), and (c) make reference to ideas contained in posts. The two ways to interact can behave in a synergistic way and allow the conversation bot to include a “human in the loop”in a surprisingly scalable way.

During the communication between the individual member and the conversation bot, the DCN (142) can analyze the individual member's responses. Based on the input from the individual member, the DCN (142) may identify an adverse health condition or a lifestyle condition for the individual member. The conversation bot may then gather more information regarding the adverse health condition, for example, to develop more details to confirm the adverse health condition. The communication may be based on related experiences from another member of the population. The conversation bot may quote content from a post by that other member.

The synergy between the conversation bot and the DCN (142) can facilitate reflection on a topic. Alternatively, this can be seen to be reversed where the act of facilitating reflection synergizes with usage of the bot in the DCN (142).

Using analysis of the individual member's communications in the DCN (142), the conversation bot can suggest a reflection on a topic in a one-to-one communication. The suggestion may be made as part of a question to the individual member. The conversation bot may then focus its conversations with that individual member on that topic for a period of time (e.g., a number of exchanges, a few minutes, a few days, etc.). The conversation bot can incorporate excerpts of communication on the DCN (142) in its responses. The excerpts of communications may include post titles, post topics, quotes from the body of the communication, and/or post contributors. Also, the excerpts could be summaries of communications on the DCN (142). These summaries may be created automatically by the DCN (142) and/or are based on a topic, a member's communications, or a time period.

The bot may prompt the individual member to reflect on various classes of action. The action may be active or passive. The action may also be one that was contemplated even if not undertaken.

Two or more conversation bots, each with a different personality or a different role (e.g. facilitate reflections, find useful communications, say good morning and inspire a positive start to a day, handle routine network tasks, provide custom communication summaries), may be provided by the DCN (142). The family of bots could each use conversations between the other bots and the user on the DCN (142) to formulate their responses. When working with an individual member, the bots may be selected based on the personality of the bot that is expected to work best with that user. The decision may be based on past dealings with the individual member and/or through analysis of that individual member's communication on the DCN (142). For example, when attempting to induce a reflection, the bot may use a first personality, then switch to a second personality when helping draft a post regarding that reflection. Accordingly, various embodiments can be used to provide a method to improve the communications of the conversation bot through using authentic experiences of the individual member in the communication.

The system shown in FIG. 1 also may include one or more user devices (150). The user devices (150) may be considered remote or local. A remote user device is a device operated by a third-party (e.g., an end user of a chatbot) that does not control or operate the system of FIG. 1. Similarly, the organization that controls the other elements of the system of FIG. 1 may not control or operate the remote user device. Thus, a remote user device may not be considered part of the system of FIG. 1.

In contrast, a local user device is a device operated under the control of the organization that controls the other components of the system of FIG. 1. Thus, a local user device may be considered part of the system of FIG. 1.

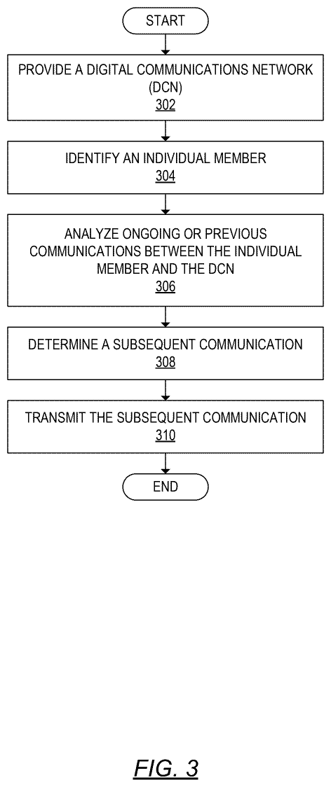

In any case, the user devices (150) are computing systems (e.g., the computing system (300) shown in FIG. 3A) that communicate with the server (130). The user devices (150) may include a wearable monitor (156) and be configured to send stress indicator data (110) to the server (130). In an alternative embodiment, a separate wearable device may be in communication with the user device (150), such as a smart watch, or blood pressure monitor. The user devices (150) may also include a user input device (152) and/or a display device (154).

In contrast, a local user device is a device operated under the control of the organization that controls the other components of the system of FIG. 1. Thus, a local user device may be considered part of the system of FIG. 1.

While FIG. 1 shows a configuration of components, other configurations may be used without departing from the scope of one or more embodiments. For example, various components may be combined to create a single component. As another example, the functionality performed by a single component may be performed by two or more components.

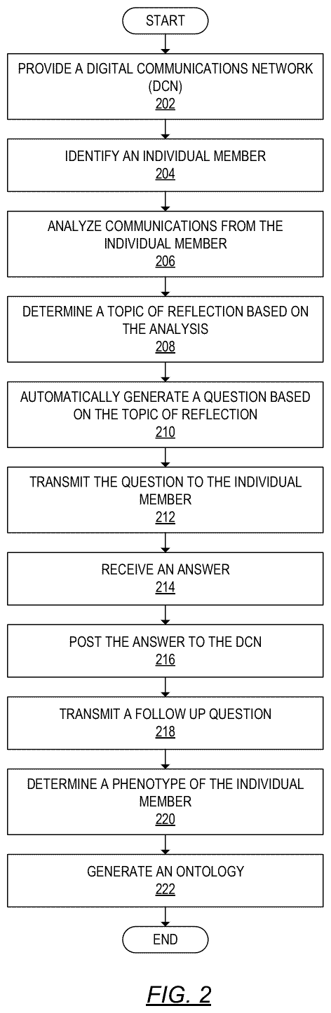

FIG. 2 is a logic flow diagram that illustrates a method, and a result of execution of computer program instructions, in accordance with various embodiments. The method can be used to determine a topic of reflection and generate question(s) based on the determined topic of reflection. The method can also, in other instances, be used in part to facilitate or accomplish at least one of: manage the health care cost of the population; reduce the health care risk in the population; and/or slow the progression of an adverse health condition. The adverse health condition can be, for example, chronic systemic inflammation, malaise, low energy, a disease, a health risk, social dysfunction, or a prodromal disease. In embodiments where the adverse health condition is a disease, the disease can be, for example obesity, diabetes, rheumatoid arthritis, Crohn's disease, psoriasis, eczema, cardiovascular disease, congestive heart failure, chronic obstructive pulmonary disease, asthma, depression, or anxiety. In embodiments where the adverse health condition is a health risk, the health risk can be, for example falling or becoming infected with an illness.

At Block 202, a step of providing a digital communication network (DCN) to a population is provided. The DCN may be the same as or similar to the DCN (142). As previously described, members of the population enrolled in the DCN can communicate with each other or with the DCN itself. The members of the population can also communication with one or more conversation bots.

At Block 204, a step of identifying an individual member based on at least one communication is provided. The communication may be the same as or similar to the communication (110) and can include an observation such as the observation (124). The observation may be related to at least one of the individual member's life, lifestyle, and health. In some embodiments, the communications may be a post by the individual member in the DCN and the post includes the at least one observation.

The individual member may be identified by, for example, the DCN. The individual member may be identified based on, for example, their recent participation in an activity, posts by the individual member indicating that the individual member recently made a decision based on their health, etc.

At Block 206, a step of analyzing the at least one communication is provided. The communication may be analyzed by, for example, a communication analyzer such as the communication analyzer (136).

At Block 208, a step of determining a topic of reflection based on the analysis is provided. The communication analyzer may identify or determine the topic of reflection, which may be the same as or similar to the topic of reflection (112) based on the communications and/or the observation. The topic of reflection may be determined by, for example, identifying key words or concepts in the communications. In embodiments where the communication is an answer such as the answer (116), the communication analyzer may identify additional topics of reflections and/or observations. As previously described, the topic of reflection may include, for example, an inspirational quote the individual member has identified as useful; a piece of music, a movie, a piece of art, a selection of prose, or a piece of poetry the individual member has identified as appreciating; a daily routine a life event; a time of year; a season; a time of day; a diagnosis; an injury; an elective medical procedure; a current challenge which the individual member has given themselves or is experiencing; a relationship; or a planned or unplanned trip.

Alternatively, the topic of reflection may be determined by user input from the individual member. In such embodiments, a list of a plurality of topics of reflections may be presented to the individual member via the DCN and the individual member may select the a topic of reflection from the list.

At Block 210, a step of automatically generating a question based on the topic of reflection is provided. The question may be the same as or similar to the question (114). The question may be generated or designed to cause the individual member to connect an outcome experienced by the individual member with a decision made by the individual member or an action the individual member has taken. For example, the action may be participating in a yoga class and the question may ask whether the individual member's mood has improved (e.g., the outcome) due to participating in the yoga class.

At Block 212, a step of transmitting the question to the individual member is provided. The question may be transmitted to the individual member via the DCN. In some embodiments, transmitting the question may include transmitting an incentive such as the incentive (120) with the question to the individual member to encourage the individual member to answer the question.

At Block 214, a step of receiving an answer is provided. The answer may be received by the DCN as user input via a user device such as the user device (150) from the individual member. The answer is in response to the question and may include, for example, a connection or reflection of the outcome experienced by the individual member with the decision made by the individual member or the action the individual member has taken. For example, the question may ask whether the individual member's mood has improved (e.g., the outcome) due to participating in the yoga class and the individual member's answer may indicate a positive connection between the individual member's mood and participating in the yoga class.

At Block 216, a step of posting the answer to the DCN is provided. The answer may be posted to the DCN by the DCN. The answer may be posted to encourage other members of the population to reflect on the connection between their own outcome(s) and decisions or actions taken by the other members. The answer may be posted anonymously or may identify the individual member.

Additionally, the individual member's reflections can be used to provide the individual member's experience as a social aspect. As a social process, value can be placed on those members of a community that have relevant experience. The reflections from the members can be induced in order to help elevate the aspects of the experience that may be more instructional to the community as a whole. This can help increase the number of members of the community thinking about an action, for example, creating an atmosphere where people can learn about others in who have undergone a change they are considering.

At Block 218, a step of transmitting a follow up question is provided. The follow up question may be the same as or similar to the question generated in the Block 210. The follow up question may be based in part on the answer received from the individual member in the Block 214. The follow up question may be designed to encourage further reflection by the individual member on the topic of reflection or may introduce a different topic of reflection.

At Block 220, a step of determining a phenotype of the individual member is provided. The phenotype may be the same as or similar to the phenotype (122). As previously described, the phenotypes may be collections of aspects that define the individual member's health and wellbeing such as, for example, the diseases and prodromal diseases they manifest, their vital signs, their body measurements and biomarker levels, there emotional state, their age, their fitness state, activity level, diet, allergies, etc. The phenotype can be determined during the analysis of the communications in the Block 206. The phenotype can also be used in determining the topic of reflection in the Block 208, generating a list of topics of reflection, and/or in generating the question in the Block 210. For example, the individual member's phenotype may include an emotional state or mood that is below average and the question generated may ask the individual member if participating in yoga has positively increased their emotional state or mood.

At Block 222, a step of generating an ontology is provided. The ontology may be the same as or similar to the ontology (118). As previously described, the ontology is a defined set of relationships between the adverse condition, ideas, motivations, and/or reflections and how the adverse condition, ideas, motivations, and/or reflections relate to each other. The ontology can define a set of terms and relational expressions that represent the entities in that subject area. The ontology defines the concept behind the language uses and may be associated with various terms and phrases. The DCN is able to analyze the words used by the members in order to determine the underlying idea, for example, exhaustion may be associated with feelings of tiredness, lack of sleep, etc.

The ontology is also used to, for example, define and show the interdependency of the individual member's adverse condition and reflection. For example, the adverse health condition may be low energy and the ontology may show that reflection on the positive improvement to the individual member's mood after participating in yoga can improve the individual member's low energy.

The method described in FIG. 2 can include more or less steps. One or more steps or any combination of steps may also be repeated in the method described in FIG. 2.

FIG. 3 is a logic flow diagram that illustrates a method, and a result of execution of computer program instructions, in accordance with various embodiments. The method can be used to induce or encourage reflection in an individual member through conversation with a conversation bot in the DCN. The method can also, in other instances, be used in part to facilitate or accomplish at least one of: manage the health care cost of the population; reduce the health care risk in the population; and/or slow the progression of an adverse health condition. The adverse health condition can be, for example, chronic systemic inflammation, malaise, low energy, a disease, a health risk, social dysfunction, or a prodromal disease. In embodiments where the adverse health condition is a disease, the disease can be, for example obesity, diabetes, rheumatoid arthritis, Crohn's disease, psoriasis, eczema, cardiovascular disease, congestive heart failure, chronic obstructive pulmonary disease, asthma, depression, or anxiety. In embodiments where the adverse health condition is a health risk, the health risk can be, for example falling or becoming infected with an illness.

At Block 302, a step of providing a digital communication network (DCN) to a population is provided. The Block 302 is the same as or similar to the Block 202 of FIG. 2 described above.

At Block 304, a step of identifying an individual member based on at least one communication is provided. The Block 304 is the same as or similar to the Block 204 of FIG. 2 described above.

At Block 306, a step of analyzing ongoing or previous communications between the individual member and the DCN is provided. The communications from ongoing or previous communications between the individual member and the DCN may be analyzed by, for example, a communication analyzer such as the communication analyzer (136). The communication analyzer may identify, for example, an observation such as the observation (124) and/or topics of reflection such as the topics of reflection (112).

At Block 308, a step of generating a subsequent communication is provided. The subsequent communication may be generated based on the observation and/or the topics of reflection identified in the Block 306. For example, the conversation bot may focus its conversations and subsequent communication(s) with the individual member on the identified topic for a period of time (e.g., a number of exchanges, a few minutes, a few days, etc.). The conversation bot can incorporate excerpts of communication on the DCN in its responses.

The excerpts of communications may include post titles, post topics, quotes from the body of the communication, and/or post contributors. Also, the excerpts could be summaries of communications on the DCN. These summaries may be created automatically by the DCN and/or are based on a topic, a member's communications, or a time period.

At Block 310, a step of transmitting the subsequent communication is provided. The subsequent communication may be transmitted to the individual member from the DCN. For example, the DCN may transmit the subsequent communication to an inbox of the individual member. In another example, the DCN may transmit the subsequent communication via a conversation bot. In such example, the conversation bot may use, for example, a visual or graphical interface, for example, a rendered avatar, to converse with the individual member.

The method described in FIG. 3 can include more or less steps. One or more steps or any combination of steps may also be repeated in the method described in FIG. 3.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 4A, the computing system (400) may include one or more computer processor(s) (402), non-persistent storage device(s) (404), persistent storage device(s) (406), a communication interface (408) (e.g., Bluetooth interface, infrared interface, network interface, optical interface, etc.), and numerous other elements and functionalities that implement the features and elements of the disclosure. The computer processor(s) (402) may be an integrated circuit for processing instructions. The computer processor(s) (402) may be one or more cores, or micro-cores, of a processor. The computer processor(s) (402) includes one or more processors. The computer processor(s) (402) may include a central processing unit (CPU), a graphics processing unit (GPU), a tensor processing unit (TPU), combinations thereof, etc.

The input device(s) (410) may include a touchscreen, keyboard, mouse, microphone, touchpad, electronic pen, or any other type of input device. The input device(s) (410) may receive inputs from a user that are responsive to data and messages presented by the output device(s) (412). The inputs may include text input, audio input, video input, etc., which may be processed and transmitted by the computing system (400) in accordance with one or more embodiments. The communication interface (408) may include an integrated circuit for connecting the computing system (400) to a network (not shown) (e.g., a local area network (LAN), a wide area network (WAN) such as the Internet, mobile network, or any other type of network) or to another device, such as another computing device, and combinations thereof.

Further, the output device(s) (412) may include a display device, a printer, external storage, or any other output device. One or more of the output device(s) (412) may be the same or different from the input device(s) (410). The input device(s) (410) and output device(s) (412) may be locally or remotely connected to the computer processor(s) (402).

Many different types of computing systems exist, and the aforementioned input device(s) (410) and output device(s) (412) may take other forms. The output device(s) (412) may display data and messages that are transmitted and received by the computing system (400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid-state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (402), is configured to perform one or more embodiments, which may include transmitting, receiving, presenting, and displaying data and messages described in the other figures of the disclosure.

The computing system (400) in FIG. 4A may be connected to, or be a part of, a network. For example, as shown in FIG. 4B, the network (420) may include multiple nodes (e.g., node X (422) and node Y (424), as well as extant intervening nodes between node X (422) and node Y (424)). Each node may correspond to a computing system, such as the computing system shown in FIG. 4A, or a group of nodes combined may correspond to the computing system shown in FIG. 4A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (400) may be located at a remote location and connected to the other elements over a network.

The nodes (e.g., node X (422) and node Y (424)) in the network (420) may be configured to provide services for a client device (426). The services may include receiving requests and transmitting responses to the client device (426). For example, the nodes may be part of a cloud computing system. The client device (426) may be a computing system, such as the computing system shown in FIG. 4A. Further, the client device (426) may include or perform all or a portion of one or more embodiments.

The computing system of FIG. 4A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

Various operations described are purely exemplary and imply no particular order. Further, the operations can be used in any sequence when appropriate and can be partially used. With the above embodiments in mind, it should be understood that additional embodiments can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and otherwise manipulated.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. Modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

The present invention may be further exemplified by one, or a combination of one or more of, the following statements:

Statement 1. A method to slow or reverse progression of an adverse health condition in an individual member of a population, the method comprising: providing a digital communication network (DCN) for members of a population to communicate with each other; selecting a topic of reflection for the individual member of the population, the topic designed to cause the individual to connect an outcome related to the topic with an action the individual has taken or a choice the individual has made sending a reflection question related to the topic to the individual through communications on the DCN.

Statement 2. The method of Statement 1, wherein the topic is an inspirational quotation the individual has identified as useful.

Statement 3. The method of Statement 1, wherein the topic is a piece of music, a movie, a piece of art, a selection of prose, or a piece of poetry the individual has identified as appreciating.

Statement 4. The method of Statement 1, wherein the topic is one of: a daily routine, a life event, a time of year, a season, and a time of day.

Statement 5. The method of Statement 1, wherein the topic is one of: a diagnosis, an injury, and an elective medical procedure.

Statement 6. The method of Statement 1, wherein the topic is a current challenge which the individual has given themselves or is experiencing.

Statement 7. The method of Statement 1, wherein the topic is a relationship.

Statement 8. The method of Statement 1, wherein the topic is a planned or unplanned trip.

Statement 9. The method of Statement 1, wherein selecting the topic of reflection comprises: providing the individual a list of topics; and receiving a selection from the list of topics as the topic of reflection.

Statement 10. The method of Statement 9, further comprising analyzing communications on the digital communication network involving the individual to determine the list of topics.

Statement 11. The method of Statement 9, further comprising determining a phenotype of the individual, wherein the list of topics is based, at least in part, on the phenotype of the individual.

Statement 12. The method of Statement 11, wherein determining the phenotype of the individual is based, at least in part, through analysis of the communications involving the individual on the DCN.

Statement 13. The method of Statement 1, wherein an incentive is provided to the individual to reflect on the topic.

Statement 14. The method of Statement 13, wherein the incentive is non-monetary.

Statement 15. The method of Statement 1, further comprising, in response to the DCN receiving an answer to the initial reflection question, sending at least one follow-up question based at least in part on the answer to the initial reflection question.

Statement 16. The method of Statement 15, wherein the initial reflection question and the at least one follow-up question are sent in a single session.

Statement 17. The method of Statement 15, wherein the initial reflection question is sent in a first session and the at least one follow-up question is sent in a subsequent session.

Statement 18. The method of Statement 17, wherein the first session is held on a first day and the subsequent session is held on a subsequent day.

Statement 19. The method of Statement 1, wherein the DCN comprises an AI bot configured to generate the reflection questions from analysis of communication in the DCN or from biometrics provided to the DCN.

Statement 20. The method of Statement 19, wherein the AI bot comprises a large language model.

Statement 21. The method of Statement 19, wherein the AI bot is configured to automatically generate the questions based, at least in part, on analysis of communications involving the individual on the DCN.

Statement 22. The method of Statement 19, wherein the AI bot is configured to generate the reflection questions based, at least in part, on previous conversations on the DCN between the individual and the AI bot.

Statement 23. The method of Statement 1, further comprising receiving a response to the reflection question and posting the response to the DCN.

Statement 24. The method of Statement 1, further comprising analyzing communication in the DCN to generate an ontology of health conditions for the individual, wherein the ontology of health conditions comprises the adverse health condition.

Statement 25. The method of Statement 1, wherein the adverse health condition comprises at least one of: chronic systemic inflammation, malaise, and low energy.

Statement 26. The method of Statement 1, wherein the adverse health condition comprises a disease.

Statement 27. The method of Statement 26, wherein the disease comprises at least one of: obesity, diabetes, rheumatoid arthritis (RA), Crohn's disease, psoriasis, eczema, cardiovascular disease (CVD), congestive heart failure (CHF), chronic obstructive pulmonary disease (COPD), insomnia, sleep quality disorders, asthma, depression, and anxiety.

Statement 28. The method of Statement 1, wherein the adverse health condition comprises a prodromal version of a disease.

Statement 29. The method of Statement 1, wherein the adverse health condition comprises a health risk.

Statement 30. The method of Statement 29, wherein the health risk comprises at least one of: a risk of falling, and a risk of becoming infected.

Statement 31. The method of Statement 1, wherein the adverse health condition comprises social dysfunction.

Statement 32. The method of Statement 1, wherein communications in the DCN comprise at least one of: one-to-one communications, one-to-many communications, one-to-system communications, system-to-one communications, and system-to-many communications.

Statement 33. The method of Statement 1, wherein the topic is derived by analysis of observations made by the individual which are related to a life, lifestyle, or health of the individual in the DCN.

Statement 34. A method to manage a disease risk in a population or lower a risk of health care expenditures in the population, the method comprising: providing a DCN for members of the population to communicate with each other; selecting a topic of reflection for an individual member of the population, the topic designed to cause the individual to connect an outcome related to the topic with an action the individual has taken or a choice the individual has made; and sending a reflection question to an individual to reflect on the topic through communications on the DCN.

Statement 35. The method of Statement 34, wherein the topic is an inspirational quotation the individual has identified as useful.

Statement 36. The method of Statement 34, wherein the topic is a piece of music, a movie, a piece of art, a selection of prose, or a piece of poetry the individual has identified as appreciating.

Statement 37. The method of Statement 34, wherein the topic is one of: a daily routine, a life event, a time of year, a season, and a time of day.

Statement 38. The method of Statement 34, wherein the topic is one of: a diagnosis, an injury, and an elective medical procedure.

Statement 39. The method of Statement 34, wherein the topic is a current challenge which the individual has given themselves or is experiencing.

Statement 40. The method of Statement 34, wherein the topic is a relationship.

Statement 41. The method of Statement 34, wherein the topic is a planned or unplanned trip.

Statement 42. The method of Statement 34, wherein selecting the topic of reflection comprises: providing the individual a list of topics; and receiving a selection from the list of topics as the topic of reflection.

Statement 43. The method of Statement 42, further comprising analyzing communications on the DCN involving the individual to determine the list of topics.

Statement 44. The method of Statement 42, further comprising determining a phenotype of the individual, wherein the list of topics is based, at least in part, on the phenotype of the individual.

Statement 45. The method of Statement 44, wherein determining the phenotype of the individual is based, at least in part, through analysis of the communications involving the individual on the DCN.

Statement 46. The method of Statement 34, wherein an incentive for the individual to reflect on the topic is provided.

Statement 47. The method of Statement 46, wherein the incentive is non-monetary.

Statement 48. The method of Statement 34, further comprising, in response to the DCN receiving an answer to the initial reflection question, sending at least one follow-up question based at least in part on the answer to the reflection question.

Statement 49. The method of Statement 48, wherein the initial reflection question and the at least one follow-up question are sent in a single session.

Statement 50. The method of Statement 48, wherein the initial reflection question is sent in a first session and the at least one follow-up question is sent in a subsequent session.

Statement 51. The method of Statement 50, wherein the first session is held on a first day and the subsequent session is held on a subsequent day.

Statement 52. The method of Statement 34, wherein the DCN comprises an AI bot configured to generate the reflection questions from analysis of communication in the DCN or from biometrics provided to the DCN.

Statement 53. The method of Statement 52, wherein the AI bot comprises a large language model.

Statement 54. The method of Statement 52, wherein the AI bot is configured to automatically generate the reflection questions based, at least in part, on analysis of communications involving the individual on the DCN.

Statement 55. The method of Statement 52, wherein the AI bot is configured to generate the reflection questions based, at least in part, on previous conversations on the DCN between the individual and the AI bot.

Statement 56. The method of Statement 34, further comprising receiving a response to the reflection questions and posting the response to the DCN.

Statement 57. The method of Statement 34, further comprising analyzing communication in the DCN to generate an ontology of health conditions for the individual, wherein the ontology of health conditions comprises the adverse health condition.

Statement 58. The method of Statement 34, wherein the adverse health condition comprises at least one of: chronic systemic inflammation, malaise, and low energy.

Statement 59. The method of Statement 34, wherein the adverse health condition comprises a disease.

Statement 60. The method of Statement 59, wherein the disease comprises at least one of: obesity, diabetes, rheumatoid arthritis (RA), Crohn's disease, psoriasis, eczema, cardiovascular disease (CVD), congestive heart failure (CHF), chronic obstructive pulmonary disease (COPD), insomnia, sleep quality disorders, asthma, depression, and anxiety.

Statement 61. The method of Statement 34, wherein the adverse health condition comprises a prodromal version of a disease.

Statement 62. The method of Statement 34, wherein the adverse health condition comprises a health risk.

Statement 63. The method of Statement 61, wherein the health risk comprises at least one of: a risk of falling, and a risk of becoming infected.

Statement 64. The method of Statement 34, wherein the adverse health condition comprises social dysfunction.

Statement 65. The method of Statement 34, wherein communications in the DCN comprise at least one of: one-to-one communications, one-to-many communications, one-to-system communications, system-to-one communications, and system-to-many communications.

Statement 66. The method of Statement 34, wherein the topic is derived by analysis of observations made by the individual which are related to a life, lifestyle, or health of the individual in the DCN.

Statement 67. A method to slow or reverse progression of an adverse health condition in an individual member of a population, the method comprising: providing a digital communication network (DCN) for members of the population to communicate with each other; analyzing the individual member's communications on the DCN related to observations around the individual member's life, lifestyle, wellbeing or health; and asking the individual a question designed to cause the individual to connect an outcome related to the observation made with an action the individual has taken or a choice the individual has made.

Statement 68. A method to slow the progression of an adverse health condition in an individual member of a population, the method comprising: providing a digital communication network (DCN) for members of the population to communicate with each other; analyzing communications on the DCN to determine at least one of: data from the DCN, an ongoing conversation with the individual member, and a previous conversations with the individual member; and formulating a next message of a conversation with the individual using a conversation bot based at least in part on the analysis.

What is claimed is:

1. A method comprising:
providing a digital communication network (DCN) for a plurality of members of a population to communicate;
identifying an individual member of the plurality of members;
analyzing one or more communications of the individual member;
determining a topic of reflection from a plurality of topics of reflections based on the analysis of the one or more communications;
generating automatically a question based on the topic of reflection, the question designed to cause the individual member to connect an outcome experienced by the individual member with a decision the individual member has made; and
transmitting the question to the individual member via the DCN.

2. The method of claim 1, further comprising:
determining a phenotype of the individual member based on the analysis of the one or more communications, wherein the plurality of topics of reflections is based, at least in part, on the phenotype of the individual member.

3. The method of claim 1, further comprising:
receiving an answer to the question from the individual member; and
transmitting at least one follow-up question based at least in part on the answer.

4. The method of claim 1, further comprising:
receiving an answer to the question from the individual member; and
posting the answer to the DCN.

5. The method of claim 1, wherein the method is used to at least one of to manage a disease risk in the population, lower a risk of health care expenditures, or to slow or reverse progression of an adverse health condition in the individual member.

6. The method of claim 5, further comprising:
generating an ontology of health conditions for the individual member, wherein the ontology of health conditions comprises the adverse health condition.

7. The method of claim 1, wherein the topic of reflection is at least one of an inspirational quote the individual member has identified as useful; a piece of music, a movie, a piece of art, a selection of prose, or a piece of poetry the individual member has identified as appreciating; a daily routine a life event; a time of year; a season; a time of day; a diagnosis; an injury; an elective medical procedure; a current challenge which the individual member has given themselves or is experiencing; a relationship; or a planned or unplanned trip.

8. The method of claim 1, wherein the topic of reflection is determined by the individual member selecting the topic of reflection from the plurality of topics of reflections.

9. The method of claim 1, wherein transmitting the question to the individual member includes transmitting an incentive to answer the question with the question.

10. The method of claim 1, wherein the one or more communications include one or more observations by the individual member regarding to a life, lifestyle, or health of the individual member.

11. A system comprising:
a computer processor;
a data repository in communication with the computer processor and storing:
one or more communications having one or more observations by the individual member regarding to a life, lifestyle, or health of the individual member;
a plurality of topics of reflections; and
a question;
a digital communications network which, when executed by the computer processor, provides a network for a plurality of members of a population to interact with each other; and
a server controller which, when executed by the computer processor:
identifies an individual member of the plurality of members;
analyzes the one or more communications;
determines a topic of reflection of the plurality of topics of reflections based on the analysis of the one or more communications;
generates the question based on the topic of reflection, the question designed to cause the individual member to connect an outcome experienced by the individual member with an action the individual member has taken; and
transmits the question to the individual member.

12. The system of claim 11, wherein the server controller which, when executed by the computer processor, further:
determines a phenotype of the individual member based on the analysis of the one or more communications, wherein the plurality of topics of reflections is based, at least in part, on the phenotype of the individual member.

13. The system of claim 11, wherein the server controller which, when executed by the computer processor, further:
receives an answer to the question from the individual member; and
transmits at least one follow-up question based at least in part on the answer.

14. The system of claim 11, wherein the server controller which, when executed by the computer processor, further:
receives an answer to the question from the individual member; and
posts the answer to the DCN.

15. The system of claim 11, wherein the system is used to at least one of to manage a disease risk in the population, lower a risk of health care expenditures, or to slow or reverse progression of an adverse health condition in the individual member.

16. The system of claim 15, wherein the server controller which, when executed by the computer processor, further:
generates an ontology of health conditions for the individual member, wherein the ontology of health conditions comprises the adverse health condition.

17. The system of claim 11, wherein the topic of reflection is at least one of an inspirational quote the individual member has identified as useful; a piece of music, a movie, a piece of art, a selection of prose, or a piece of poetry the individual member has identified as appreciating; a daily routine a life event; a time of year; a season; a time of day; a diagnosis; an injury; an elective medical procedure; a current challenge which the individual member has given themselves or is experiencing; a relationship; or a planned or unplanned trip.

18. The system of claim 11, wherein the topic of reflection is determined by the individual member selecting the topic of reflection from the plurality of topics of reflections.

19. The system of claim 11, wherein transmitting the question to the individual member includes transmitting an incentive to answer the question with the question.

20. A method comprising:
providing a digital communication network (DCN) for a plurality of members of a population to communicate;
identifying an individual member of the plurality of members;
analyzing one or more communications including at least one of an ongoing conversation between the DCN and the individual member or a previous conversation between the DCN and the individual member; and
determining a subsequent communication for at least one of the ongoing conversation or the previous conversation based at least in part on the analysis of the one or more communications.
